(19) United States
(12) Patent Application Publication
(10) Pub. No.: US 2004/0047107 A1
(43) Pub. Date: Mar. 11, 2004

(54) ESD protection circuit for touch button

(76) Inventor: Chih-Chung Hsu, Taipei (TW)

Correspondence Address: BIRCH STEWART KOLASCH & BIRCH, PO BOX 747, FALLS CHURCH, VA, 22040-0747, US

(21) Appl. No.: 10/235,544

(22) Filed: Sep. 6, 2002

(51) Int. Cl. H02B 1/00

(52) U.S. Cl. 361/220

(57) ABSTRACT

An ESD protection circuit for touch button aims at protecting the touch sensor IC located in the button key from damage by electrostatic discharge. The button key has a touch control section that extends to form a first point corresponding to a second point of a discharge section. Applying the point discharge principle, the first point and the second point generate point discharge, thereby the electrostatic discharge is channeled to the ground circuit and the touch sensor IC may be protected from damage.

### FIELD OF THE INVENTION

The invention relates to a touch button adopted for a touch operation interface of electronic devices, and particularly a touch button with ESD protection.

### BACKGROUND OF THE INVENTION

The touch button is a widely used button key structure. Compared with the conventional press button key, it responds faster, is more reliable and can reduce a user's fatigue. In general, the touch button has a touch sensor IC connecting to the button key. When a user touches the button key, the touch sensor IC detects the change of the capacitance and activates the internal circuit. Although it is convenient, the touch sensor IC is sensitive to electrostatic discharge.

Electro-Static Discharge (ESD) mainly comes from the human body. When people walk, friction occurs on the clothes or the casings of electronic devices that are on the path of the air convection. This friction generates electrostatic discharges, which are accumulated on the surfaces of the electronic devices. When the accumulated electrostatic discharges reach a certain level, an electrostatic discharge takes place and may cause malfunction of the electronic devices or even damage the electronic devices. Hence the electronic devices often require a special element or circuit to avoid such incidents.

On the touch button, when the electrostatic discharge hits from the human body or the surface of an electronic device, the touch sensor IC 40 is easily damaged, as FIG. 1. The commonly adopted approach to protect electronic devices from the harmful effect of the electrostatic discharge is painting. A conductive material is added to non-conductive acetate-based baking paints to make the paint layer become a semiconductor. The paint layer is properly grounded so that electrostatic discharges generated by the friction between the clothes of people and the air convection can be channeled to the ground. However such an approach cannot be adopted on the touch button because once the touch button is painted with electrostatic resistant paint, it becomes non-conductive and cannot function properly.

Therefore the most commonly used method is to add a protective IC 41 inside or outside the touch sensor IC 40, as FIG. 2. But such an approach significantly increases the cost. In addition, the general protection design has the capacity of only 2 KV, while electrostatic discharge can be easily greater than 5 KV. Thus the conventional protection design is not effective.

### SUMMARY OF THE INVENTION

The object of the invention is to provide an ESD protection circuit for touch button to overcome the problems set forth above and to flow the electrostatic discharge into the ground before reaching the touch sensor IC so that the touch sensor IC may be protected.

The ESD protection circuit for touch button of the invention adopts the point discharge principle to flow the electrostatic discharge to the ground without affecting the functions of the touch button key.

According to the invention, the circuit board of the touch button is laid out at least one point. And the point is corresponding to another point connecting to the ground. Electrostatic discharge entering into the button key generates a point discharge between the two points. Thus the electrostatic discharge flows into the ground circuit before reaching the touch sensor IC.

In order to ensure that the electrostatic discharge is point discharged, the circuit of the touch sensor IC further includes a resistor. So the effective resistance of the touch sensor IC is greater than the effective resistance between the two points. Such a design can effectively trigger point discharge and channel the electrostatic discharge to the ground circuit to protect the touch sensor IC.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the circuit of the touch button.

FIG. 2 is a schematic view of the circuit with a protection IC.

FIG. 3 is a schematic view of the invention.

FIG. 4 is a schematic view of the invention, including a resistor.

FIG. 5 is a schematic view of another embodiment of the invention with a symmetrical structure.

FIG. 6 is a schematic view of another embodiment of the invention to form protection circuit by attaching copper foil.

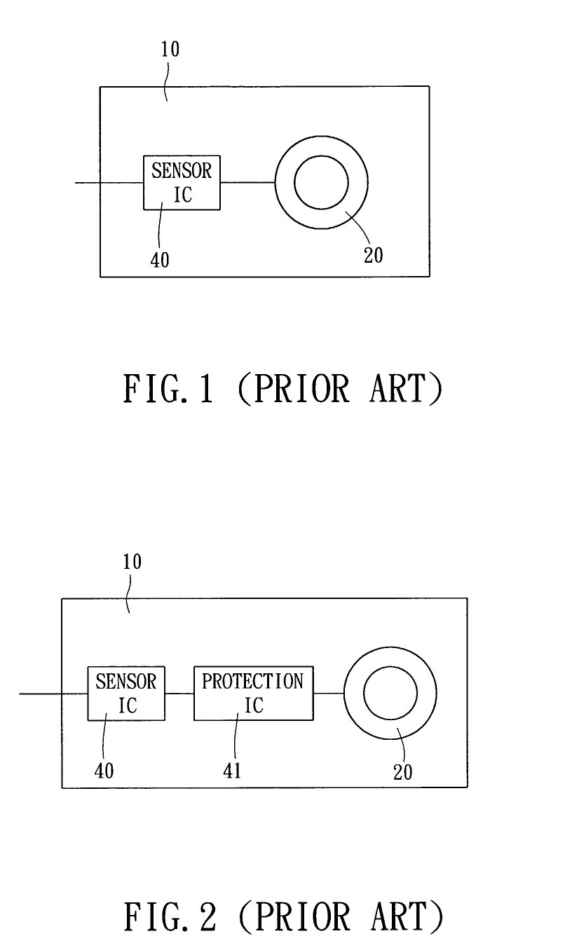

### DESCRIPTION OF THE PREFERRED EMBODIMENTS

The ESD protection circuit for touch button according to the invention employs the point discharge principle based on the considerations that the touch button cannot be directly connected to the ground. The touch sensor IC would be protected from being damaged by the electrostatic discharge without affecting its function and performance.

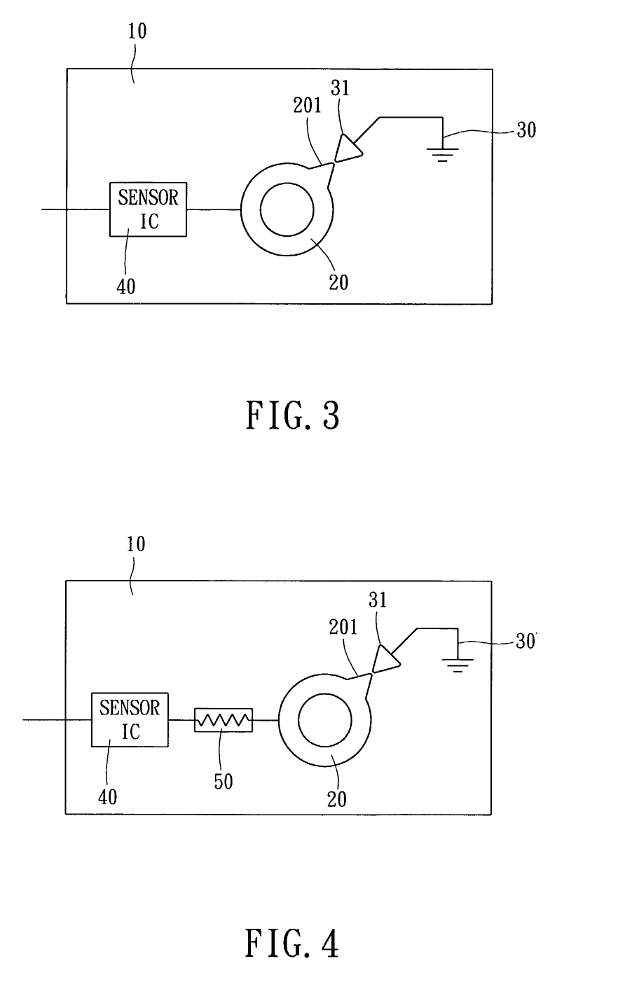

Referring to FIG. 3, the touch button of the invention includes a circuit board 10, which has a touch control section 20, a touch sensor IC 40 and a discharge section. The touch control section 20 links to the exterior for receiving the touch actions of users and is electrically connected to the touch sensor IC 40. The discharge section includes a second point 31, which connects to a ground circuit 30 and corresponds to a first point 201 extended from the touch control section 20. The first point 201 and the second point 31 face each other and may be the naked copper foil on the circuit board 10.

The touch control section 20 receives user's touch actions from an exposed button key portion. In the event that an electrostatic discharge occurs and is transmitted to the touch control section 20, the first point 201 of the touch control section 20 and the second point 31 of the discharge section generate point discharge therebetween. The electrostatic discharge flows into the ground circuit 30. As the touch sensor IC 40 is activated by detecting the change of the capacitance, transmission of the electrostatic discharge to the ground circuit 30 does not affect the function and performance of the touch sensor IC 40.

In order to ensure that the electrostatic discharge is discharged through the point discharge, the principle that electricity flows to where the resistance is lowest may be adopted. Thus a resistor 50 may be included between the electrostatic sensor IC 40 and the touch control section 20, as shown in FIG. 4, so that the effective resistance of the electrostatic sensor IC 40 is greater than the effective resistance between the first point 201 and the second point 31. Therefore the electrostatic discharge is forced to discharge between the first point 201 and the second point 31, and is channeled to the ground circuit 30.

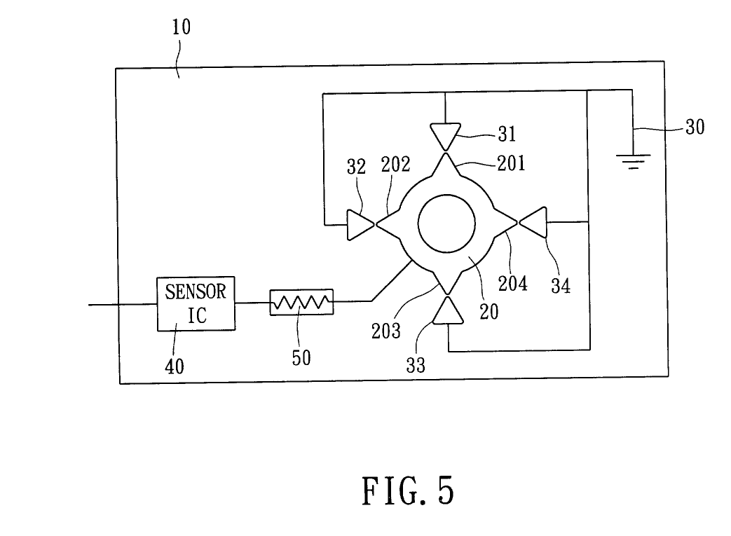

Taking into account structural symmetry and ensuring that discharge is accomplished in a short time, a plurality of points may be adopted. Referring to FIG. 5, the touch control section 20 has four points 201, 202, 203, and 204 located on the periphery in a symmetrical fashion and connected to the touch sensor IC 40. The discharge section has four points 31, 32, 33 and 34 corresponding to the four points 201, 202, 203, and 204 of the touch control section 20, and connecting respectively to the ground circuit 30. As a result, the electrostatic discharge can be effectively channeled to the ground circuit 30.

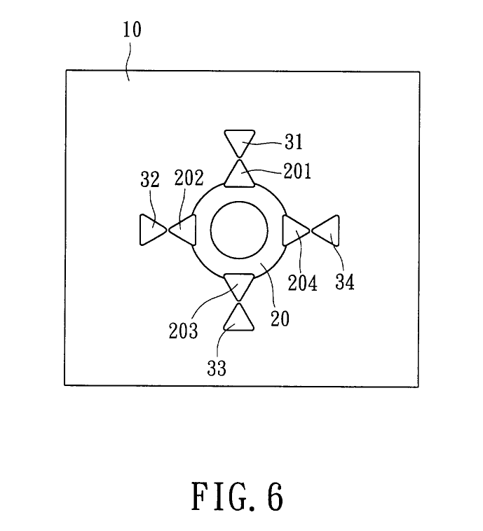

The four points 31, 32, 33 and 34 of the discharge section and the four points 201, 202, 203, and 204 of the touch control section 20 are formed by layout circuit on the circuit board 10, as shown in FIG. 5. It also attaches copper foil on the circuit board 10 to form the four points 31, 32, 33 and 34 of the discharge section and the four points 201, 202, 203, and 204 around the touch control section 20, referring to FIG. 6.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An ESD protection circuit for touch button connecting to a touch sensor IC to detect change of capacitance of a button key resulting from a touch action, comprising:
a touch control section connecting electrically to the touch sensor IC for receiving the touch action and transmitting the touch action to the touch sensor IC and having at least one first point; and
a discharge section electrically connected to a ground circuit having at least one second point corresponding to the first point of the touch control section to generate a point discharge effect for channeling electrostatic discharge to the ground circuit.

2. The ESD protection circuit for touch button of claim 1 further having a resistor bridged and connected the touch control section and the touch sensor IC.

3. The ESD protection circuit for touch button of claim 2, wherein the resistance value of the resistor is greater than the effective resistance value formed between the first point of the touch control section and the second point of the discharge section.

4. The ESD protection circuit for touch button of claim 1, wherein the first points of the touch control section are symmetrical to the center of the touch control section.

5. The ESD protection circuit for touch button of claim 1, wherein the first point of the touch control section is a naked metal.

6. The ESD protection circuit for touch button of claim 5, wherein the naked metal is a copper foil.

7. The ESD protection circuit for touch button of claim 1, wherein the second point of the discharge section is a naked metal.

8. The ESD protection circuit for touch button of claim 7, wherein the naked metal is a copper foil.
